(19) United States
(12) Patent Application Publication
(10) Pub. No.: US 2014/0203557 A1
(43) Pub. Date: Jul. 24, 2014

(54) System and Method for Extending Minimum Turn Down Load of Combined Cycle Power Plant

(71) Applicant: GENERAL ELECTRIC COMPANY, Schenectady, NY (US)

(72) Inventors: Kihyung Kim, Atlanta, GA (US); Seyfettin Can Gulen, Schenectady, NY (US)

(73) Assignee: GENERAL ELECTRIC COMPANY, Schenectady, NY (US)

(21) Appl. No.: 13/749,656

(22) Filed: Jan. 24, 2013

(51) Int. Cl. F02C 3/22; F01K 23/10

(52) U.S. Cl. CPC F02C 3/22; F01K 23/10
USPC 290/2; 60/39.12; 60/39.182; 60/780

(57) ABSTRACT

A system including a gas turbine system and an electrolysis unit configured to produce a hydrogen gas for reducing a minimum emissions compliance load of the gas turbine system.

### BACKGROUND OF THE INVENTION

The subject matter disclosed herein relates to power plants and, more specifically, emissions compliance in a power plant.

Combined cycle power plants combine gas turbine systems with steam turbine systems to produce electricity while reducing energy waste. In operation, the gas turbine system combusts a fuel-air mixture to create rotational energy that drives a load (i.e., creates electrical power). The combustion gases may include various combustion by-products, such as carbon monoxide (CO), nitrogen oxides (NOₓ), carbon dioxide (CO₂), and so on. In order to reduce energy waste, the combined cycle power plants use the thermal energy in the gas turbine system exhaust gases to create steam, for use in a steam turbine system. Unfortunately, electrical grids may receive power from a variety of sources, decreasing combined cycle power plant power production requirements (i.e., loading). The decrease in power requirements may cause the gas turbines in the plant to operate outside of minimum emissions compliance loads (MECL) constraints (i.e., exceed exhaust gas emissions levels with respect to their loading). Accordingly, combined cycle power plants may turn on and off more frequently in order to comply with emissions regulations, and thus increase maintenance costs, and startup costs among others.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system including a gas turbine system and an electrolysis unit configured to produce a hydrogen gas for reducing a minimum emissions compliance load of the gas turbine system.

In another embodiment, a system including, a gas turbine system configured to drive a load with combustion gases, a heat recovery steam generator configured to generate steam by recovering heat from the combustion gases, and an electrolysis unit configured to receive the steam from the heat recovery steam generator for use in producing hydrogen gas to reduce a minimum emissions compliance load of the gas turbine system.

In another embodiment, a method including, creating hydrogen gas in an electrolysis unit, capturing the hydrogen gas in a storage container, monitoring at least one parameter of a gas turbine system, and routing the hydrogen gas into the gas turbine system to lower a minimum emissions compliance load in response to the at least parameter.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a combined cycle power plant with an electrolysis unit;

FIG. 2 is a graph illustrating different emissions levels with respect to gas turbine system loads;

FIG. 3 is an embodiment of a method for extending a minimum emission compliance load for a combined cycle power plant; and

FIG. 4 is an embodiment of a method for extending a minimum emission compliance load for a combined cycle power plant.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is generally directed to a system and method for extending the minimum emissions compliance load for a combined cycle power plant. Specifically, the combined cycle power plant includes an electrolysis unit that produces hydrogen gas fuel for the gas turbine system. The combined cycle power plant uses the hydrogen gas to dope the gas turbine fuel, which reduces emissions during periods of limited loading of the gas turbine system (e.g., loading below a reference minimum emissions compliance load). As will be appreciated, a reduction in emissions during periods of lower loading enables the combined cycle power plant to remain operational (i.e., avoids frequent starts and shutdowns), while complying with emissions standards. In order to produce hydrogen gas, the electrolysis unit may use high temperature and pressure steam from the HRSG, produce steam within the electrolysis unit, or a combination thereof. In other words, the electrolysis unit may be electrically powered by the combined cycle power plant (e.g., the generator driven by the gas turbine system) or the electrolysis unit may be driven by heat energy (e.g., steam) generated by the plant (e.g., the HRSG).

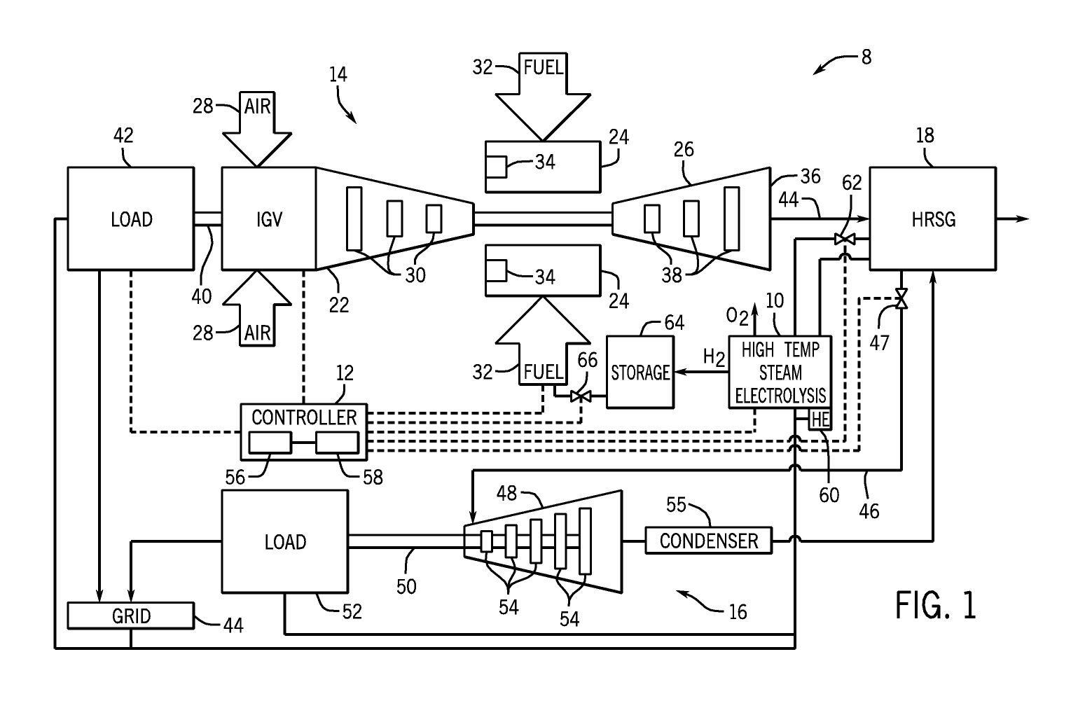

FIG. 1 is a block diagram of an embodiment of a combine cycle power plant (CCPP) 8 with an electrolysis unit 10. During operation, the CCPP 8 uses the electrolysis unit 10 to produce hydrogen gas for fuel doping. Electrolysis is a process of using a direct current to drive a chemical reaction (i.e., H₂O into H₂ and O₂). The direct current for electrolysis may come from CCPP 8 (e.g., electrical generators) and/or the grid. The hydrogen doped fuel reduces emissions, thus enabling the CCPP 8 to operate at a lower minimum emission compliance load. In other words, the CCPP 8 uses the electrolysis unit 10 to produce hydrogen that extends the minimum emissions compliance load (MECL) during periods of limited loading (i.e., low power production). The combined cycle power plant (CCPP) 8 includes the electrolysis unit 10, a controller 12, a gas turbine system 14, a steam turbine system 16, and a heat recovery steam generator (HRSG) 18. In operation, the gas turbine system 14 combusts a fuel-air mixture to create rotational energy that drives a load (e.g., an electrical generator). In order to reduce energy waste, the combined cycle power plant 8 use the thermal energy in the exhaust gases to heat a fluid (e.g., water) and create steam in the HRSG 18. The steam travels from the HRSG 18 through a steam turbine system 16 creating rotational energy that then drives a load (e.g., an electrical generator). Accordingly, the CCPP 8 combines the gas turbine system 14 with steam turbine system 16 to increase power production while reducing energy waste.

The gas turbine system 14 may include a compressor 22, a combustor 24, and a turbine 26. In operation, air 28 enters the turbine system 14 through the inlet guide vane 20, which controls the amount of oxidant intake (e.g., air intake). Although the gas turbine system 14 may use air 28 as an oxidant as discussed below, the system 14 may use any suitable oxidant, such as air, oxygen, oxygen enriched air, or oxygen reduced air. The compressor 22 pressurizes the air 28 in a series of compressor stages (e.g., rotor disks 30 with compressor blades). As the compressed air exits the compressor 22, the air enters the combustor 24 and mixes with fuel 32. The turbine system 14 may use a gas fuel, such as natural gas, syngas, coke oven gas, blast furnace gas, and/or a hydrogen rich gas (i.e., hydrogen doped gas), to run the turbine system 14. For example, the fuel nozzles 34 may inject a fuel-air mixture into the combustor 24 in a suitable ratio for optimal combustion, emissions, fuel consumption, and power output. As depicted, a plurality of fuel nozzles 34 intakes the fuel 32, mixes the fuel 32 with air, and distributes the air-fuel mixture into a combustor 24. The air-fuel mixture combusts in a chamber within combustor 24, thereby creating hot exhaust gases. The combustor 24 directs the exhaust gases through a turbine 26 toward an exhaust outlet 36. As the exhaust gases pass through the turbine 26, the gases contact turbine blades attached to turbine rotor disks 38 (e.g., turbine stages), thereby driving rotation of the rotor disks 38. The rotation of the rotor disks 38 induces rotation of shaft 40 and the rotor disks 30 in the compressor 26. A load 42 (e.g., an electrical generator) connects to the shaft 40 and uses the rotation energy of the shaft 40 to generate electricity for use by the power grid 44.

As explained above, the CCPP 8 harvests energy from the hot exhaust gases exiting the gas turbine system 14 for use by the steam turbine system 16. Specifically, the CCPP 8 channels hot exhaust gases 44 from the turbine system 14 into the heat recovery steam generator (HRSG) 18. In the HRSG 18, the thermal energy in the combustion exhaust gases turns a fluid (e.g., water) into hot pressurized steam. The HRSG 18 releases the steam 46 through valve(s) 47, for use in the steam turbine system 16.

The steam turbine system 16 includes a turbine 48, shaft 50, and load 52 (e.g., electrical generator). As the hot pressurized steam 46 enters the steam turbine 48, the steam 46 contacts turbine blades attached to turbine rotor disks 54 (e.g., turbine stages). As the steam 46 passes through the turbine stages in the turbine 48, the steam 46 induces the turbine blades to rotate the rotor disks 54. The rotation of the rotor disks 54 induces rotation of the shaft 50. As illustrated, the load 52 connects to the shaft 50. Accordingly, as the shaft 50 rotates, the load 52 (e.g., electrical generator) uses the rotation energy to generate electricity for the power grid 44. As the pressurized 46 steam passes through the turbine 48, the steam 46 loses energy (i.e., expands and cools). After exiting the steam turbine 48, the steam 46 is routed to back to the HRSG 18 or condenser 55.

In order to produce hydrogen gas, the electrolysis unit 10 may use high temperature/pressure steam to improve the electrolysis unit 10 efficiency, and thus production of hydrogen gas for use in extending the minimum emission compliance load. The electrolysis unit 10 may receive high temperature steam from an internal source (e.g., HRSG 18), produce high temperature steam (e.g., within unit 10), or a combination thereof. For example, in one embodiment, the electrolysis unit 10 may generate hydrogen gas using high temperature steam from the HRSG 18. During operation, the controller 12 may execute instructions (e.g., stored on memory 56 and executable on processor 58) to control operation of the electrolysis unit 10 and the entire CCPP 8. For example, the controller 12 may execute instructions for opening valve 60. As valve 60 opens, high temperature steam exits the HRSG 18 and flows into the electrolysis unit 10. As the electrolysis unit 10 receives high temperature steam, the unit 10 performs electrolysis, separating water into hydrogen and oxygen gases. As illustrated, the hydrogen gas may be stored in a storage tank 64, while the discharged steam or condensed water is routed back into the HRSG 18 or condenser 55 for reheating. In another embodiment, the electrolysis unit 10 may generate high temperature steam via a heat exchanger 60. For example, the controller 12 may execute instructions for the heat exchanger 60 to generate steam in the electrolysis unit 10. The heat exchanger 60 may include an electrical heater, a fin and tube heat exchanger, or any suitable heater configured to transfer heat to water and/or steam to generate a suitable steam for electrolysis. The heat exchanger 60 may receive electrical power or thermal energy from the load 42, load 52, grid 44, a furnace, boiler, solar energy, another thermal source in the CCPP 10, or a combination thereof. In still another embodiment, the electrolysis unit 10 may receive high temperature steam from the HRSG 18, which is then further heated with the heat exchanger 60. In this manner, the heat exchanger 60 may increase the temperature of the steam in order to facilitate hydrogen gas production. The use of thermal energy and electrical power from the CCPP 8 to drive the electrolysis chemical reaction may reduce the efficiency of the CCPP 8, including the efficiency of the bottoming cycle (i.e., the steam turbine system 16), but enables the CCPP 8 to remain operational at a lower MECL. The ability to keep the CCPP 8 operational and on the electrical grid reduces costs associated with frequent starts and stops (i.e., maintenance, savings in startup costs, higher dispatch rank, more revenue from power generation, etc.).

As explained above, the CCPP 8 uses the electrolysis unit 10 to extend the minimum emissions compliance load, reducing frequent CCPP 8 shutdowns and restarts. The minimum emission compliance load (MECL) is an emissions standard for gas turbine systems, wherein the gas turbine system 14 may not continue to operate if the load (e.g., power production) is below a threshold load value that produces emissions in excess of designated levels. Thus, in order to prevent the CCPP 8 from frequently starting and shutting down, the disclosed embodiments extend the MECL of the CCPP 8 through hydrogen gas fuel doping for the gas turbine system 14. The hydrogen gas in the fuel 32 reduces emissions (e.g., NOx, CO, etc.), enabling the gas turbine system 14 to operate at lower loads (i.e., lower power outputs), while remaining within emissions standards. As will be appreciated, the CCPP 8 uses the controller 12 to monitor the operating parameters (e.g., loading, emissions, fuel composition, etc.) of the gas turbine system 14 and to adjust the fuel composition in the gas turbine system 16. The controller 12 includes the memory 56 and the processor 58. The memory 56 stores instructions and steps written in software code, which the processor 58 executes in response to feedback from the CCPP 8. Specifically, the controller 12 monitors the load 42 in combination with the fuel composition 32 or the gas turbine emissions to determine whether the load of the gas turbine system 14 is above the minimum emission compliance load. If the load is below the MECL, then the controller 12 may execute instructions to dope the fuel 32 for the gas turbine system 14. For example, the controller 12 may dope the fuel with hydrogen gas using a database of known values, equations, models, etc. that predicts emissions levels based on amounts of hydrogen doping. In another embodiment, the controller 12 may monitor the load and the emissions (e.g., CO, NOₓ, CO₂) to determine whether the gas turbine system 14 is operating below the minimum emissions compliance load, and then dope based on the emissions feedback. During operation, the controller 12 may open valve 66, releasing hydrogen gas for use in the gas turbine system 14. The hydrogen gas changes the composition of the fuel 32, thus reducing emissions. The reduction in emissions enables the gas turbine system 14 to operate at lower loads, and still comply with emissions standards (i.e., extend the minimum emissions compliance load). By extending the MECL, the CCPP 8 may therefore remain operational during times of low power requirements, preventing costly shutdowns and startups.

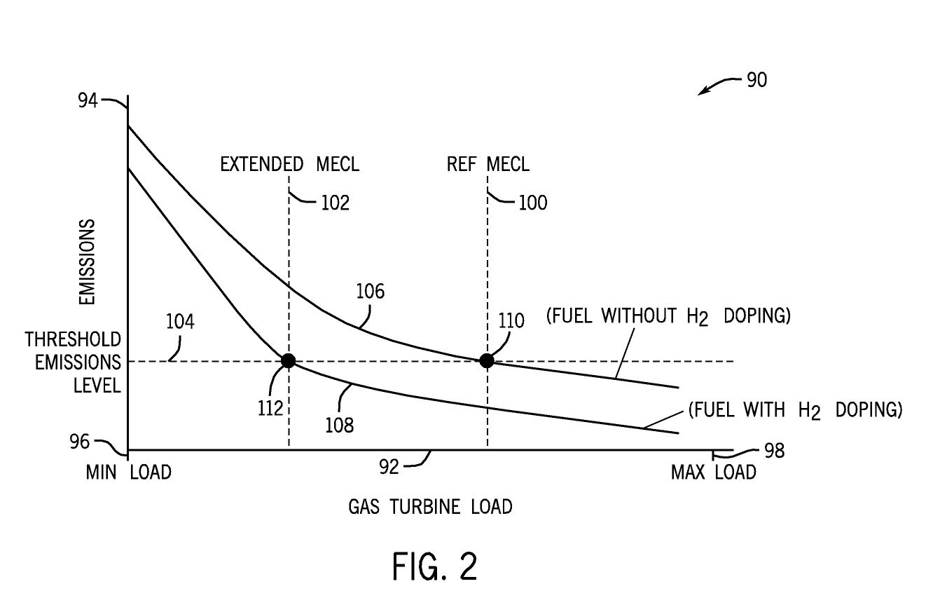

FIG. 2 is a graph 90 illustrating emissions levels with respect to gas turbine system loads. The graph 90 includes an x-axis 92 and a y-axis 94. The x-axis 92 represents loading of the gas turbine system 14, including a minimum load 96, a maximum load 98, reference minimum emissions compliance load 100, and extended minimum emissions compliance load 102. The y-axis 94 represents emissions from the gas turbine system 14, and defines a threshold emissions level 104. As illustrated, the graph 90 illustrates two emissions curves 106 and 108 with respect to the load on the gas turbine system 14. The emissions curve 106 illustrates emissions of the gas turbine system 14 without hydrogen doped fuel, while the emissions curve 108 illustrates emissions with hydrogen doped fuel.

As explained above, the emissions curve 106 illustrates emissions for the gas turbine system 14 using un-doped fuel. As will be appreciated, as the load on the gas turbine system 14 increases, the emissions level decreases to point 110. At point 110, the gas turbine system 14 is operating at the minimum emissions compliance load 100, or the point where the loading of gas turbine system 14 produces emissions that are at the threshold emissions level 104. In order to comply with the threshold emissions level 104, the gas turbine system 14 may maintain a load at or above the reference minimum emissions compliance load 100. As explained above, it is desirable to maintain the CCPP 8 in an operational state (i.e., avoid costly plant shutdowns and startups). However, the loading (e.g., power production requirements) may not be at or above the reference minimum emissions compliance load 100. Accordingly, and as explained above, the CCPP 8 includes an electrolysis unit 10 that generates hydrogen for fuel doping, in order to extend the minimum emissions compliance load.

The curve 108 illustrates the emissions levels of the gas turbine system 14 with respect to the load when using the hydrogen doped fuel. As illustrated, when the loading of gas turbine system 14 increases, the emissions curve 108 intersects the threshold emission level 104 at point 112. More specifically, when the gas turbine system 14 uses hydrogen doped fuel, the emissions drop more rapidly as loading increases (e.g., curve 108), than when the un-doped fuel is used (e.g., curve 106). Accordingly, emissions curve 108 intersects the emission threshold 104 before the emissions curve 106. In this manner, the hydrogen doped fuel enables the gas turbine system 14 to operate at an extended minimum emission compliance load 102 (i.e., a lower load), and still comply with emissions standards.

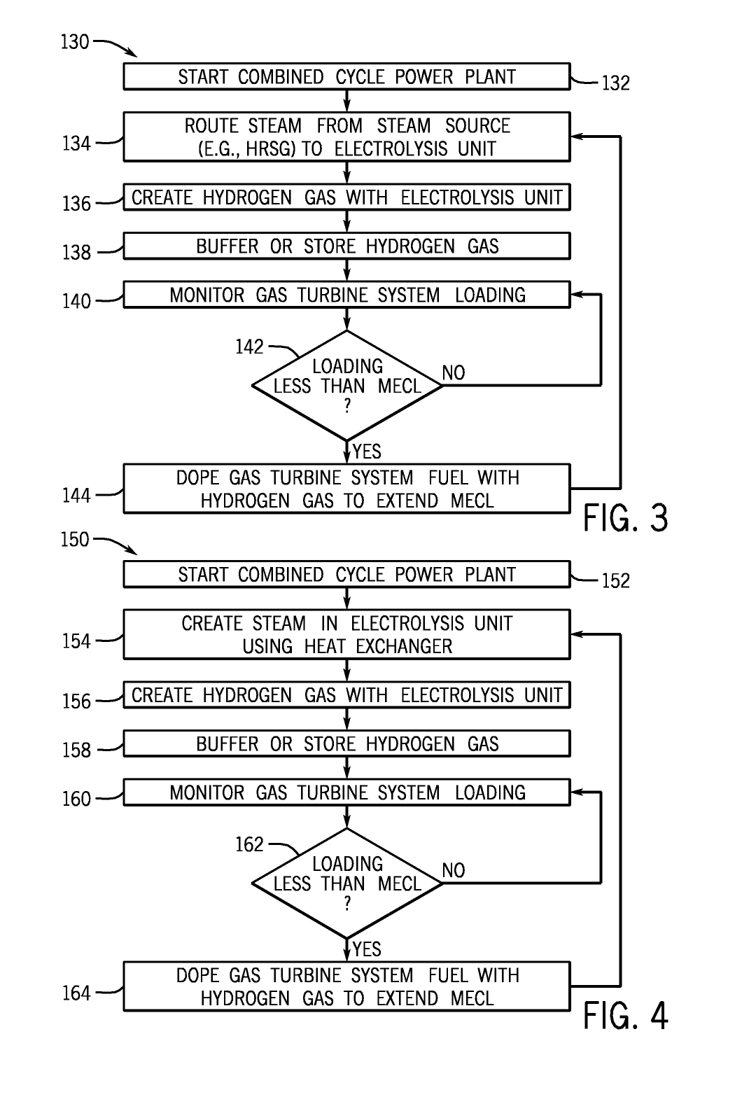

FIG. 3 is an embodiment of a method 130 for extending a minimum emission compliance load for the combined cycle power plant 8. The method 130 begins by starting the combined cycle power plant 8 (block 132). Once operational, the controller 12 executes instructions routing steam from a steam source (e.g., HRSG, or other steam source in the power plant) to the electrolysis unit 10 (block 134). The electrolysis unit 10 uses the steam to create hydrogen gas for use in fuel doping (block 136). As explained above, doping fuel with hydrogen reduces emissions and extends the minimum emissions compliance load (i.e., enables CCPP 8 to comply with emissions standards at lower loads). After production, the hydrogen gas is stored in the buffer or storage tank 64 (block 138). As the electrolysis unit 10 produces hydrogen gas, the controller 12 monitors the loading of the gas turbine system 14 (block 140). While monitoring the load on the gas turbine system 14, the controller 12 determines whether the load is less than the minimum emissions compliance load (decision point 142). If the controller 12 determines that the loading is above the minimum emissions compliance load, the controller 12 returns to block 140 and monitors the gas turbine system 14. However, if the controller 12 determines that the load is less than the minimum emissions compliance load, the controller 12 executes instructions to dope the gas turbine system 14 fuel with the stored hydrogen gas, thus extending the minimum emission compliance load (block 144). In some embodiments, the controller 12 may execute instructions to produce hydrogen gas on demand with the electrolysis unit 10 when the load is less than the minimum emissions compliance load (i.e., instead of storing hydrogen gas). As explained above, extending the minimum emissions compliance load enables the CCPP 8 to remain operational (i.e., reduce costly shutdowns and startups) at lower loads, while complying with emissions standards.

FIG. 4 is an embodiment of a method 150 for extending a minimum emission compliance load for the combined cycle power plant 8. The method 130 begins by starting the combined cycle power plant 8 (block 152). Once operational, the controller 12 executes instructions to create steam in the electrolysis unit 10 with the heat exchanger 60 (block 154). As explained above, the heat exchanger 60 may receive electrical and/or thermal energy from a variety of sources (e.g., load 42, load 44, grid 44, HRSG, or another part of the CCPP 8). The electrolysis unit 10 uses the steam to create hydrogen gas for use in fuel doping (block 156). As explained above, doping fuel with hydrogen reduces emissions and extends the minimum emissions compliance load (i.e., enables CCPP 8 to comply with emissions standards at lower loads). After production, the hydrogen gas is stored in the buffer or storage tank 64 (block 158). As the electrolysis unit 10 produces hydrogen gas, the controller 12 monitors the loading of the gas turbine system 14 (block 160). While monitoring the load on the gas turbine system 14, the controller 12 determines whether the load is less than the minimum emissions compliance load (decision point 162). If the controller 12 determines that the loading is above the minimum emissions compliance load, the controller 12 returns to block 140 and continues to monitor the gas turbine system 14. However, if the controller 12 determines that the load is less than the minimum emissions compliance load, the controller 12 executes instructions to dope the gas turbine system 14 fuel with the stored hydrogen gas, thus extending the minimum emission compliance load (block 164). In some embodiments, the controller 12 may execute instructions to produce hydrogen gas on demand with the electrolysis unit 10 when the load is less than the minimum emissions compliance load (i.e., instead of storing hydrogen gas). As explained above, extending the minimum emissions compliance load enables the CCPP 8 to remain operational (i.e., reduce costly shutdowns and startups) at lower loads, while complying with emissions standards.

Technical effects of the invention include the ability to extend the minimum emissions compliance load for a combined cycle power plant. Specifically, the disclosed embodiments describe a combined cycle power plant with an electrolysis unit that produces hydrogen gas for use in doping fuel. The combined cycle power plant uses the hydrogen doped fuel to decrease emissions during periods of limited loading. In this manner, the combined cycle power plant remains operational at lower loads (i.e., avoids frequent starts and shutdowns), while remaining within emissions standards.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
a gas turbine system; and
an electrolysis unit configured to produce a hydrogen gas for reducing a minimum emissions compliance load of the gas turbine system.

2. The system of claim 1, wherein the electrolysis unit is configured to generate the hydrogen gas from a supply of steam.

3. The system of claim 2, comprising a first electrical generator driven by the gas turbine system.

4. The system of claim 3, wherein the first electrical generator is configured to supply an electrical power to the electrolysis unit.

5. The system of claim 2, comprising a heat recovery steam generator configured to recover heat from an exhaust output by the gas turbine system, generate the steam with the recovered heat, and supply the steam to the electrolysis unit.

6. The system of claim 5, comprising a steam turbine system coupled to the heat recovery steam generator.

7. The system of claim 6, comprising a second electrical generator driven by to the steam turbine system.

8. The system of claim 7, wherein the second electrical generator is configured to supply an electrical power to the electrolysis unit.

9. The system of claim 1, comprising a storage container configured to store the hydrogen gas created by the electrolysis unit for use by the gas turbine system.

10. A system comprising:
a gas turbine system configured to drive a load with combustion gases;
a heat recovery steam generator configured to generate steam by recovering heat from the combustion gases; and
an electrolysis unit configured to receive the steam from the heat recovery steam generator for use in producing hydrogen gas to reduce a minimum emissions compliance load of the gas turbine system.

11. The system of claim 10, comprising a storage container configured to capture the hydrogen produced by the electrolysis unit.

12. The system of claim 10, comprising a controller configured to control a supply of the hydrogen gas from the electrolysis unit to the gas turbine system based on at least one monitored parameter indicative of a load on the gas turbine system.

13. The system of claim 12, wherein the controller is configured to route the hydrogen gas to the gas turbine system when the monitored parameter indicates that the load is below a threshold level.

14. The system of claim 10, comprising a first electrical generator coupled to the gas turbine system and configured to produce power for use by the electrolysis unit.

15. The system of claim 10, comprising a second electrical generator coupled to a steam turbine system and configured to produce power for use by the electrolysis unit.

16. A method comprising:
creating hydrogen gas in an electrolysis unit;
capturing the hydrogen gas in a storage container;
monitoring at least one parameter of a gas turbine system; and
routing the hydrogen gas into the gas turbine system to lower a minimum emissions compliance load in response to the at least parameter.

17. The method of claim 16, wherein creating hydrogen gas comprises electrolysis of steam into the hydrogen gas and oxygen in the electrolysis unit.

18. The method of claim 17, comprising generating the steam in a heat recovery steam generator, and supplying the steam to the electrolysis unit.

19. The method of claim 17, comprising generating the steam in the electrolysis unit.

20. The method of claim 16, comprising generating electrical power with an electrical generator coupled to the gas turbine system, a steam turbine system, or a combination thereof, for use in the electrolysis unit.
